(19) United States
(12) Patent Application Publication
(10) Pub. No.: US 2012/0083929 A1
(43) Pub. Date: Apr. 5, 2012

(54) Solar-Powered Self-Watering Planter Insert

(76) Inventor: Michael L. Conrad, JR., Bridgewater, NJ (US)

(21) Appl. No.: 12/895,819

(22) Filed: Sep. 30, 2010

(51) Int. Cl. G05D 7/06

(52) U.S. Cl. 700/284

(57) ABSTRACT

A self-contained insert for use with a planter to provide self-watering of container-grown plants. It has a perforated tray supported over a reservoir that contains a submersible pump, and water or nutrient solution. Plants may be in pots supported by the tray, or plant roots may be in a growth or support medium distributed directly into the tray. A height-adjustable riser supported by the tray houses the pump's controller/timer/battery. A drip line connected to the pump distributes fluid from the reservoir to plants in the tray. Solar power is used for pump operation, and may be derived from a unit secured to the riser, or a unit positioned remotely from the reservoir and tray. No municipal power or water supply connections are needed for insert function. Applications include, but are not limited to, use for daily watering of plants in residential homes, commercial buildings, hotels, convention centers, and college campuses.

### CROSS-REFERENCES TO RELATED APPLICATIONS

None.

### BACKGROUND

1. Field of the Invention

This invention relates to apparatus and systems used to provide water/fluids to container-grown plants, specifically to an insert comprising a perforated tray and a reservoir member that in combination are used within a planter to provide self-contained, self-watering of a plant or plants positioned on or above the tray, while the tray is removably supported upon a lip inwardly depending from the upper portion of the reservoir. The present invention insert is self-contained, with power for its submersible pump and controller/timer being provided by a solar panel unit, and no municipal power or water supply connections are needed for its function. Plants may be in pots supported by the tray, or plant roots may be established in a growth or support medium distributed within the tray. Water or nutrient solution from its reservoir is delivered to the plants in the tray by a drip line in fluid communication with the pump located in the reservoir. The distributed fluid then filters downwardly through the growth/support medium, with any excess fluid moving through perforations in the tray and back into the reservoir, where it is recycled. The objective of the present invention is to eliminate the daily labor that would otherwise be needed to keep container-grown plants and flowers properly irrigated.

The insert may be manufactured in multiple sizes and configurations, so that its tray and reservoir to a large extent fill an independent or existing decorative planter having a substantially circular cross-sectional configuration, a rectangular planter box, or other decorative or non-decorative plant growth container with a non-circular and non-rectangular configuration. If on-board solar power is used and the decorative or non-decorative planter associated with the present invention already has one or more drainage holes through or near its bottom surface, there is no need to alter or modify it for present invention use. However, should remotely located solar power be used to power the present invention controller/timer and pump, and/or no drainage or other holes already exist therein, it is preferred that one or more holes be formed through the side or bottom of the planter prior to its use with the present invention, for fluid drainage and/or insertion of electrical wiring used for connection between the remote solar power unit and the controller/timer. The word “planter” will generally be used in this invention disclosure hereafter, without any intent of size or shape limitation, to refer to any outer container used to house the present invention insert.

The size of the submersible pump located inside the present invention reservoir may also vary according to the volume of water needed for distribution to plants. Typically, the present invention tray is positioned below the top edge of the planter. In contrast, a height-adjustable riser supported by the tray, and which houses a controller/timer and battery power back-up and/or storage, typically extends above the top edge of the associated planter, particularly when the riser supports the solar panel unit (also referred to hereinafter as ‘on-board solar power’) that provides power for pump and controller/timer function. As an alternative to riser support, the present invention's solar panel unit may be remotely located from the reservoir and tray. Handles attached to the present invention tray assist in lowering and removing the tray from its position of use on the reservoir's supporting lip. Also, the controller/timer is programmable so that the desired frequency and duration of watering cycles can be varied according to need at each planter installation site. Should additional fluid be needed in the reservoir, the insert's tray has a fill-hole opening through it, and tray removal is not required. In addition, the reservoir also preferably has two side openings, a higher one that reduces the likelihood of fluid in the reservoir moving upwardly through the tray and growth/support medium where it could cause over-watering of plants, and a lower drain opening that during reservoir use is preferably sealed with a threaded cap, and may be employed for maintenance purposes. Applications include, but are not limited to, use for daily watering of plants in residential homes, commercial buildings, hotels, convention centers, and college campuses.

2. Description of the Related Art

People enjoy plants, but depending upon their location, plants can require a lot of maintenance. In heated and air-conditioned buildings, humidity is generally low, and more frequent watering of indoor plants is typically needed. Also, indoor temperature, sunlight level, air drafts, and positioning near a door that subjects a plant to frequently changing local conditions, can have a significant affect on a plant's need for water and nutrients. Container-grown plants that are located outdoors and in patio areas can be subjected to even more variation in ambient temperature, sunlight level, and air movement, all of which will affect the plant's moisture requirements. The goal of the present invention is to eliminate the daily labor that would otherwise be needed to keep container-grown plants and flowers properly irrigated. While irrigation devices are known for container-grown plants with pumps and wicking features, none is known with the advantageous combination of features found in the present invention.

The prior art invention thought to be the closest to the present invention is disclosed in U.S. Patent Application Publication 2008/0303002 to Schmidt (2008), which also provides an irrigation device for a planter. However, there are many important structural differences between the Schmidt invention and the present invention, which allow the present invention structure to provide advantages that the Schmidt invention cannot. First, the present invention is a self-contained unit that is lowered into a planter, and comprises a reservoir and a tray, with the tray being supported by a lip formed into the upper inside surface of the reservoir. In contrast, and as shown in Schmidt's FIG. 5, the Schmidt invention is integrated into a planter and comprises two vertically-oriented spacers 51 and 51 positioned in the bottom of a planter, in addition to a horizontally-extending plate 50 supported upon the spacers that defines a bottom volume that can be used as a water supply volume. Since the present invention is a self-contained apparatus, its tray and reservoir can be promptly and cleanly removed from a planter without delay, saving material and labor cost. In contrast, for the Schmidt invention, with its growth medium, water, spacer, and horizontal plate 50 all integrated into the planter, each would have to be individually removed, a task that could not be conducted as efficiently and cleanly as when the present invention apparatus is used. This provides the present invention with an important and significant advantage over the Schmidt invention.

A second important difference between the present invention and the Schmidt invention involves pump activation and water/fluid delivery. In the present invention, a programmable controller/timer is used to provide different time intervals and duration of fluid delivery to a plant or plants via a drip line. Excess fluid passes through the tray's perforations and re-enters the reservoir, where it is recycled. In contrast, the Schmidt pump is activated when a humidity sensor placed into the soil above its plate 50 detects moisture below a pre-determined threshold level, with the quantity of water delivered to the soil by a hose 46 being also fixed in advance. Furthermore, in addition to the moisture readings periodically taken that can result in pump activation if the moisture reading falls below a desired level, the Schmidt sensor may also be instructed to take a humidity measurement after water delivery via its hose 46 is complete. Then, if the Schmidt invention detects that the time between successive pump activations increases, its controller will lessen the amount of water delivered during each pump activation, and conversely, if the time between successive pump activations decreases, the Schmidt controller will increase the amount of water delivered for each pump activation, thus attempting to maintain a more uniform range of moisture for plant growth and reducing the probability of excess moisture returning to its water supply volume for recycling. Although both inventions have a fill tube for replenishment of fluid to its reservoir, the movement of water from the present invention's tray to its reservoir for recycling use is an important feature of the present invention, something that the Schmidt invention's controller is programmed to minimize.

A third important difference between the present invention and the Schmidt invention is pump placement. The present invention's pump and controller/timer are separate units in electrical communication with one another. Its pump is placed in the bottom of the reservoir, while the controller/timer is housed in a riser supported by the tray, with the present invention riser being height-adjustable preferably through use of multiple vertically-stacked, spaced-apart, and inwardly-depressible protrusions. In contrast, the Schmidt invention has a miniature irrigation unit 30 that includes both a pump and its controller. Thus, should a pump malfunction occur during use of the present invention, its tray can be easily lifted from the reservoir for pump inspection and/or maintenance, without disturbing the plant(s), growth/support medium, or drip line associated with its tray. In contrast, while the Schmidt invention's miniature irrigation unit 30 can be removed from the soil and water supply volume built into an associated planter without disturbing its plate 50 and the spacers supporting plate 50 should pump malfunction occur, withdrawal of the Schmidt submersible pump from its reservoir location is much more messy and time-consuming than for the present invention, and unless at least some soil is first removed from the area around recess 54 in non-woven water-permeable material 53, soil that is otherwise prevented from entering the water supply volume by material 53 might then be allowed to pass through recess 54 and adversely affect subsequent pump operation.

The height-adjustable capability of the riser in the present invention is important when it supports a solar panel unit (on-board solar power), so that the solar panel unit can be periodically raised above new plant growth, as needed, to maintain a satisfactory level of power generation. In addition, the present invention is contemplated for use in public places, and as a result optionally comprises a locking means for its riser to prevent theft of, or tampering with, the controller/timer and any rechargeable or back-up batteries housed therein. Also, since the present invention is a self-contained insert lowered into a planter, some void space will be present between it and the planter for installation convenience. Thus, the present invention reservoir is able to have a lower drain hole (which is capped during use), as well as an over-fill prevention hole underneath its lip that would allow a contingency for excess fluid in the reservoir to move into the surrounding planter instead of upwardly through the growth/support medium for the plant where it could potentially dislodge the growth/support medium and/or plant/plants from their preferred positioning, or prevent needed air from reaching plant roots. In contrast, the Schmidt invention does not disclose structural features addressing any of these potentially encountered contingencies.

Other prior inventions have similarities in function and/or structure to the present invention. The invention disclosed in U.S. Pat. No. 4,056,899 to Close (1977) is a liquid-recycling planter with a base that functions as its reservoir. However, the Close invention is not a removable insert for an independent planter, and cannot provide the above-noted advantages that the present invention does as a planter insert. U.S. Patent Application Publication 2008/00732492 to Olson (2008) is also a plant watering/food dispensing system that can be imbedded a plant growth pot. However, it is different from the present invention in that, as revealed in paragraph [0024] of the Olson disclosure, its container 11 of food and water would be inserted into a hole 21 in the pot, and positioned behind a door 24 to prevent household animals from drinking out of it. In contrast, the present invention is contemplated for insert into an existing planter, not one specially constructed with a special chamber and door configured for reservoir use. Furthermore, the Olson invention does not disclose a height-adjustable riser, or a self-contained system that allows excess water from a drip line to pass through perforations in a plant tray into a reservoir below for recycling. Similarly, while the inventions in U.S. Pat. No. 5,749,170 to Futura (1998), U.S. Pat. No. 7,607,257 to Goldberg (2009), U.S. Patent Application Publication 2005/0000159 to Billette (2005), and U.S. Patent Application Publication 2005/0011124 to Sanderson (2005), each disclose a potted plant situated directly over a reservoir, none comprises the height-adjustable riser of the present invention, nor a perforated plant tray that helps to make the present invention into a self-contained system that allows excess water from a drip line to pass by plant roots and move through perforations in its plant tray into a reservoir below for recycling. No other planter insert is known that functions in the same manner as the present invention, has the same structure disclosed herein, or provides all of the present invention's important advantages.

### BRIEF SUMMARY OF THE INVENTION

It is the primary object of this invention to provide a self-contained, solar-powered, and self-watering insert for planters that eliminates the daily labor that would otherwise be needed to keep container-grown plants and flowers properly irrigated. It is also an object of this invention to provide a self-watering insert for planters that discourages unauthorized access to its pump and controller/timer, when located in public places. A further object of this invention is to provide a self-watering insert for planters that has an option for remote solar power generation, if the selected location of its supporting planter does not have adequate sun exposure for battery recharging. It is a further object of this invention to provide a self-watering insert for planters that has facilitated means for reservoir replenishment without movement of plants or their growth/support medium. It is also an object of this invention to provide a self-watering insert for planters that has facilitated means for tray removal from the supporting planter, and re-installation into its position of use. A further object of this invention is to provide a self-watering insert for planters that has a tray construction allowing fluid to pass through it and enter the reservoir underneath it for recycling. It is also an object of this invention to provide a self-watering insert for planters which has a tray constructed for holding one or more plant growth pots, or in the alternative may contain growth/support medium distributed directly into the tray for plant support. It is a further object of this invention to provide a self-watering insert for planters that has irrigation means that evenly distributes fluid to differing portions of the tray. In addition it is an object of this invention to provide a self-watering insert for planters with an option that allows alternative positioning of the riser so that a single plant can be centered relative to an associated planter.

The present invention, when properly made and used, provides a self-contained insert for use with a planter to provide self-watering of a plant or plants positioned on or above a perforated tray that is removably supported over a reservoir, to eliminate the daily labor that would otherwise be needed to keep container-grown plants and flowers properly irrigated. Multiple sizes and shapes of insert are contemplated, and although its reservoir needs periodic fluid replenishment, no municipal power or water supply connections are needed for proper function of the present invention insert. The present invention's reservoir houses a submersible pump, and water or nutrient solution that is distributed to the plants in the tray by a drip line connected to the pump. The fluid then filters downwardly through the growth or support medium, with excess fluid moving through perforations in the tray and back into the reservoir, where it is recycled. After the present invention's reservoir is lowered into an independent planter typically of comparable size, the present invention tray is lowered via handles onto a supporting lip inside the reservoir. The bottom of the present invention tray is perforated, and it holds one or more potted plants, or plant/plants rooted in a growth or support medium distributed directly into the tray.

The present invention's tray and reservoir are generally configured and sized to substantially fill an associated planter, with the topmost portion of the tray typically positioned below the planter's top edge, but not limited thereto. The size of the pump is also variable, and selected according to the volume of water contemplated for delivery during each watering cycle via a drip line to a plant or plants supported by the tray. A height-adjustable riser is also supported by the tray, which houses a controller/timer/batteries, and may optionally support a solar panel unit. The riser typically extends above the top edge of the associated planter, particularly when it supports a solar panel unit so that it can be raised as needed above new plant growth and continue to generate power for pump and controller/timer function. The present invention's controller/timer is programmable to set the desired frequency and duration of fluid delivery to the drip line situated above the tray. Should additional fluid be needed in the reservoir, the insert's tray has a fill-hole opening through it so that tray removal is not required. In addition, the reservoir also preferably has two side openings, a higher one that reduces the likelihood of fluid in the reservoir moving upwardly through the tray and growth//support medium where it could cause over-watering of plants, and a lower drain opening that during reservoir use is preferably sealed with a threaded cap.

Although one option for providing solar power to operate the pump and controller/timer is via a solar panel unit secured to the riser, a second solar power option is a solar panel unit remotely located from the reservoir and tray. In addition, although not previously mentioned, riser height adjustment is preferably made by pushing on depressible protrusions that are inwardly movable. After the new height desired for the riser is attained, letting go of the protrusions will reset them into their extended positions of use, and secure the riser into its new vertical position. Furthermore, although the riser may occupy a central positioning relative to the present invention tray, it may also have non-centered positioning, which is made possible by an optional perforated and off-center plate in the tray. Thus, when the plate is removed, it leaves an opening for riser positioning, so that a plant can instead occupy central positioning relative to the tray. Preferably, once the perforated plate is re-installed into its usable position, locking pins are used to secure/lock it in a fixed position relative to the remainder of the tray. It is also preferred that the present invention riser containing the controller/timer/batteries be made theft-resistant, so that its contents are not easily removed and tampered with, or stolen.

The description herein provides preferred embodiments of the present invention but should not be construed as limiting its scope. For example, variations in the number, height dimension, positioning, spaced-apart distance from one another, and configuration of riser protrusions used for height adjustment of the riser relative to the tray; the number, height dimension, positioning, and configuration of locking pins used for securing the perforated plate to the tray; the type of materials from which the riser, tray and reservoir are made; the size, configuration, and positioning of the handles used to lift the tray from its usable position, and reinstall it; the configuration, dimension, and positioning of the reservoir's fill-hole; and the diameter dimension of the drip line used, other than those shown and described herein, may be incorporated into the present invention. Thus the scope of the present invention should be determined by the appended claims and their legal equivalents, rather than being limited to the examples given.

### BRIEF DESCRIPTION OF THE DRAWINGS

FIG. 1 is a top view of the tray and drip line used as a part of the most preferred embodiment of the present invention, which shows two handles placed in opposed positions to one another near the perimeter of the tray, a riser centrally supported by the tray, a solar panel unit supported on top of the riser and substantially covering it, the drip line positioned in a spiral configuration above the tray, perforations through the bottom of the tray, a reservoir fill-hole near the tray's perimeter, and a lockable perforated plate adjacent to the riser and having perforations of similar size, configuration, and spaced-apart distance from one another that is similar to the perforations formed in other portions of the tray's bottom surface, with the perimeter of an associated planter used for housing the tray shown around it and marked in broken lines.

FIG. 2 is a side view of the most preferred embodiment of the present invention having its tray and reservoir marked with broken lines to show them hidden within a planter, with the top portion of the riser supported by the tray visible above the top edge of the planter, and a solar panel unit attached to the top surface of the riser.

FIG. 3 is an exploded sectional view of the most preferred embodiment of the present invention showing the submersible pump positioned within the reservoir, retractable/extendable handles associated with the tray, plant growth or support medium distributed within the tray, a fill-hole formed through the tray for reservoir fluid replenishment, protrusions depending outwardly from the riser and used for height adjustment of the riser relative to the tray, over-flow and drain holes incorporated into the reservoir that prevent over-watering of plant roots, drip line connection to the pump, two options for solar panel unit placement, and electrical connections between the controller/timer and the pump and solar panel units.

### DETAILED DESCRIPTION OF PREFERRED EMBODIMENTS

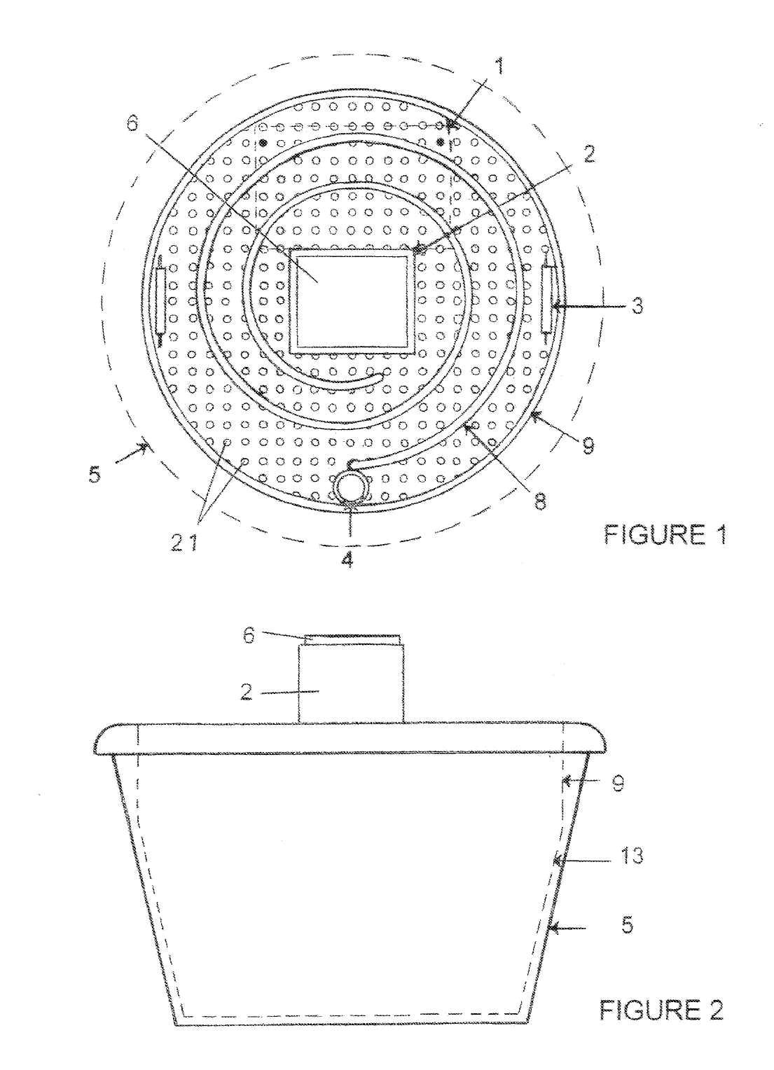

While FIGS. 1-3 show the most preferred embodiment of the present invention planter insert for self-watering of container-grown plants (not shown), it is to be understood that many variations in the present invention are possible and also considered to be a part of the invention disclosed herein, even though such variations are not specifically mentioned or shown. As a result, a reader should determine the scope of the present invention by the appended claims.

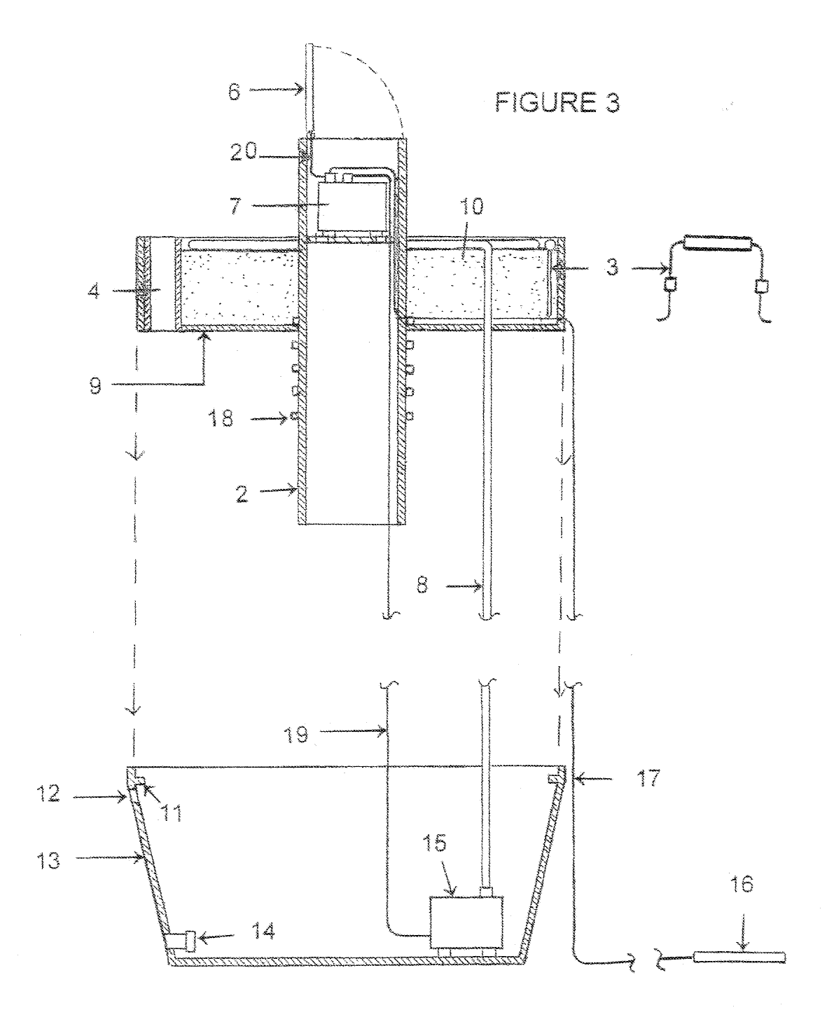

FIG. 1 is a top view of the tray 9 and drip line 8 used as a part of the most preferred embodiment of the present invention, which also shows two handles 3 placed in opposed positions to one another near the perimeter of tray 9. While FIG. 1 shows a configuration of handles 3 usable as a part of the most preferred embodiment of the present invention, the size, configuration, and positioning of handles 3 used to lift tray 9 from its usable position and reinstall it, may be different from that shown. It is also preferred for handles 3 to be extendable during use to lift or lower tray 9, and then retractable into an inconspicuous position close to the top of tray 9 after use, similar to the positioning shown on the upper right side of FIG. 3. FIG. 1 also shows a planter 5 extending around the present invention and being formed by broken lines.

In addition, FIG. 1 shows a riser 2 centrally supported by tray 9, a solar panel unit 6 supported on the top surface of riser 2, and drip line 8 positioned in a spiral configuration above tray 9. The positioning and diameter dimension of drip line 8 may be different from that shown in FIG. 1, and would be selected according to the type and number of plants supported by tray 9, as well as the amount of fluid to be delivered during each pump activation cycle to plants. FIG. 1 further shows spaced-apart perforations 21 throughout the bottom surface of tray 9 and a lockable perforated plate 1 forming part of the bottom surface of tray 9, as well as a reservoir fill-hole 4 near the perimeter edge of tray 9 that allows the addition of fluid to the reservoir while tray 9 remains supported upon the lip 11 of reservoir 13 (both shown in FIG. 3). While the configuration, dimension, and positioning of the reservoir's fill-hole 4 shown in FIG. 1 is preferred, it should not be considered as limiting. Also, the number, positioning, spaced-apart distance from one another, and configuration of perforations 21 may differ from that shown, as long as they are sufficiently large to allow adequate flow of excess fluid (not shown) downwardly into reservoir 13 for recycling, while at the same time being sufficiently small to prevent plant growth or support medium 10 (see FIG. 3) from passing downwardly through tray 9 into reservoir 13.

The present invention insert for a planter 5, which includes tray 9 and reservoir 13, may be manufactured in multiple sizes and configurations, so that tray 9 and reservoir 13 to a large extent fill an independent or existing decorative planter 5 having a substantially circular cross-sectional configuration, a rectangular planter box, or other decorative or non-decorative plant growth container with non-circular or non-rectangular configuration. The size of the submersible pump 15 located inside the present invention reservoir 13 may also vary according to the volume of water needed for distribution to plants supported by tray 9. Also, tray 9 is typically positioned below the top edge of planter 5, but is not limited thereto. In contrast, a height-adjustable riser 2 supported by tray 9, and which houses a controller/timer 7 and battery power back-up and/or storage, typically extends above the top edge of the associated planter 5. Furthermore, the type of materials from which riser 2, tray 9, and reservoir 13 are made may vary in different embodiments of the present invention.

As an alternative to support of the present invention's solar panel unit 6 by riser 2, solar panel technology may be set apart from reservoir 13 and tray 9, and positioned outside of planter 5 as a remotely-placed solar panel unit 16 (see FIG. 3). Furthermore, if on-board solar power is used, it may be located in two differing positions, centered and non-centered relative to tray 9. First, as shown in FIG. 1, a riser 2 centrally positioned relative to tray 9 may support solar panel unit 6 on or near its top end. In the alternative, and when it is desired for tray 9 to support a single centrally-located plant, lockable perforated plate 1 forming part of the bottom surface of tray 9 may be removed, allowing riser 2 to have off-center positioning. Thus, the size, configuration, and placement of riser 2 and lockable perforated plate 1 may vary from that shown in FIG. 1, as long as the dimension and configuration of riser 2 is sufficient to house controller/timer 7 and any batteries (not shown) associated therewith. Preferably, when perforated plate 1 is installed into its usable position as a part of tray 9, locking pins (not separately numbered but shown by darkened circles near the upper corners of perforated plate 1) are used to secure/lock perforated plate 1 into its fixed position of use relative to the remainder of tray 9 for secure positioning of plants (not shown) and growth/support medium 10 by tray 9. The number, positioning, and configuration of the locking pins used for securing perforated plate 1 to tray 9 may be different from that shown in FIG. 1. It should also be noted that in FIG. 3, the component marked by the number 7 is contemplated to be a controller/timer/battery unit. However, although not shown, in other embodiments of the present invention, the needed controller, timer, battery back-up and/or power storing/recharging functions may be conducted by two or more independent devices.

Should solar panel unit 6 be supported by riser 2 and the planter 5 to be associated with tray 9 and reservoir 13 already have at least one drain hole through its bottom or lower side surface, no alteration or modification of planter 5 is required for present invention use. However, should remotely-located solar panel unit 16 be used to power the present invention controller/timer 7 and pump 15, and/or no drainage or other holes already exist in planter 5, it is preferred that one or more holes be formed through the side or bottom of the planter 5 prior to its use with the present invention. Such newly formed holes would be used for drainage of fluid from planter 5, such as during the draining of water/fluid from reservoir 13 so that it can be more easily removed from planter 5. However, a newly formed hole through the side of planter 5 could be used for convenient and unobtrusive insertion of the electrical wiring 17 employed for connection of remotely-located solar power unit 16 with controller/timer 7.

As plants supported by tray 9 grow, and when on-board solar power is employed using solar panel unit 6, riser 2 may periodically need height adjustment for proper solar panel unit 6 function. Adjustment of riser 2 up or down in a vertical direction is preferably accomplished without removal of tray 9 from lip 11, and pushing in any of the preferably angled, vertically-stacked, inwardly-moveable, and spaced-apart protrusions 18 (shown in FIG. 3) exposed above tray 9. It is contemplated that inward movement of one protrusion 18 in the most preferred embodiment of the present invention will cause all of the other protrusions 18 vertically stacked with it to also move inwardly so that riser 2 is free to move vertically relative to tray 9. Once protrusions 18 are bent or flexed inward by finger-applied pressure to become recessed into a channel (not shown) formed in riser 2, and riser 2 is moved vertically relative to tray 9 into a newly desired position, then finger-applied pressure against protrusions 18 is released so that protrusions 18 regain their typically extended configuration that allows support of riser by adjacent surfaces of tray 9, which resets riser 2 into the newly desired vertical height relative to tray 9. Although a protrusion/channel arrangement for height adjustment of riser 2 is contemplated in the most preferred embodiment of the present invention, it is not critical, and other apparatus allowing rapid and easy height adjustment of riser 2 relative to tray 9 are also contemplated to be within the scope of the present invention. In addition, the number, configuration, spaced-apart distance, and height, width, and depth dimensions of the protrusions 18 on riser 2 that are used for its height adjustment relative to tray 9 are not critical, and may be different from that shown.

FIG. 2 is a side view of the most preferred embodiment of the present invention having its tray 9 and reservoir 13 positioned within an independent planter 5, with tray 9 and reservoir 13 marked in broken lines to indicate that that they would be hidden from view inside planter 5. In many applications it is preferred that tray 9 not extend above the top edge of planter 5, although such positioning is not critical. In contrast, riser 2 is generally contemplated to extend above the top edge of planter 5, particularly when it supports solar panel unit 6 so that sufficient light can reach solar panel unit 6 to power pump 15 and controller/timer 7. Furthermore, since FIG. 2 shows solar panel unit 6 supported by riser 2, and if planter 5 already had at least on drain hole therethrough (not shown), planter 5 would not undergo any alteration or modification before or during present invention use. Also, although FIGS. 1-3 show planter 5 having a generally circular cross-sectional configuration and being comparable in size to tray 9 and reservoir 13 so that tray 9 and reservoir 13 substantially fill planter 5, it is contemplated for tray 9 and reservoir 13 to be manufactured in multiple sizes and configurations, for use with an independent or existing decorative planter 5 having a substantially circular cross-sectional configuration, a rectangular planter box, or other decorative or non-decorative plant growth container with a non-circular and non-rectangular configuration. For simplicity and clarity of illustration, the lip 11 shown in FIG. 3 for support of tray 9 by reservoir 13, is not marked in FIG. 2.

FIG. 3 is an exploded sectional view of the most preferred embodiment of the present invention showing submersible pump 15 resting on the bottom of reservoir 13, the retractable/extendable handles 3 associated with tray 9, and the fill-hole 4 needed through tray 9 for reservoir 13 fluid replenishment without removal of tray 9 from its position of use. FIG. 3 also shows height-adjustment protrusions 18 depending outwardly from riser 2 above and below tray 9, which are used to periodically raise solar panel unit 6 above new plant growth and prevent diminishment of solar power generation for pump 15 and controller/timer 7. The number, size, configuration, positioning, and spaced-apart distance between adjacent protrusions 18 may be different from that shown. FIG. 3 further shows over-flow hole 12 and capped drain hole 14 through the side wall of reservoir 13, with over-flow hole 12 preferably positioned immediately below lip 11. Without over-flow hole 12, plant roots supported by tray 9 could become over-watered. Also, once tray 9 is removed from lip 11, the cap on drain hole 14 could be removed to empty reservoir 13, which would be facilitated by at least one hole (not shown) through the bottom or lower side of planter 5.

In addition, FIG. 3 shows connection of drip line 8 to pump 15, a second remotely-placed solar panel unit 16 set apart from tray 9 and reservoir 13 and positioned outside planter 5, the electrical connection 19 between the controller/timer 7 and pump 15, and the electrical connections, 17 and 20 respectively, between the controller/timer 7 and solar panel units 16 and 6. Although not shown in FIG. 3, it is contemplated for the solar panel unit 6 attached to the top of riser 2 to be secured to a hinged cover lockable against riser 2 (or otherwise be lockable), that allows authorized access to controller/timer 7 and any rechargeable or non-rechargeable batteries associated therewith, while also preventing unauthorized tampering with and/or theft of controller/timer 7 and/or batteries housed in riser 2. Also, although not shown, it is an option for extendible/retractable handles similar to those shown in FIG. 3 for use with tray 9, to be associated with riser 2 for its vertical movement relative to tray 9, when needed. For clarity of illustration, perforations 21 and lockable perforated plate 1 are not shown in FIG. 3. Also, the length of riser 2 shown in FIG. 3 relative to tray 9 and/or reservoir 13, as well as the size of handle 3 relative to tray 9, should be used only for general illustrative purposes, and no relative dimensional information derived from FIG. 3 should be considered as limiting to the scope of the present invention.

What is claimed is:

1. An insert for automated irrigation of container-grown plants and positioning within a planter, said insert comprising:
a submersible pump;
a reservoir configured to hold said pump and plant growth fluid, said reservoir also having an upper inside lip;
a tray configured for removable positioning and support upon said lip, said tray having sufficient material strength for holding plant support medium and at least one plant, said tray also having a top edge, said tray further having a bottom surface with perforations configured to allow fluid flow through said tray into said reservoir below said tray without concurrent movement of plant support medium through said perforations and into said reservoir;
a controller configured for activation of said pump;
a riser supported by said tray, said riser configured to house said controller;
a drip line positioned above said tray;
fluid communication means adapted for connection between said drip line and said pump;
a solar panel unit in electrical communication with said controller;
electrical communication means adapted for connection between said controller and said pump; and
electrical communication means adapted for connection between said controller and said solar panel unit, wherein upon activation of said pump by said controller using power derived from said solar panel unit, fluid is delivered through said drip line to said tray, and excess fluid not required by a plant supported by said tray passes through said perforations in said bottom surface of said tray and into said reservoir for recycling.

2. The insert of claim 1 further comprising handles.

3. The insert of claim 2 wherein said handles are reversibly moveable from an inconspicuous retracted position into an extended position above said top edge of said tray.

4. The insert of claim 1 wherein said solar panel unit is associated with said riser.

5. The insert of claim 1 wherein said solar panel unit is remotely located from said tray and reservoir.

6. The insert of claim 1 wherein said reservoir further comprises an overflow hole.

7. The insert of claim 1 wherein said reservoir further comprises a drain hole.

8. The insert of claim 7 wherein said drain hole is configured for connection to a threaded cap.

9. The insert of claim 1 wherein said riser is height adjustable relative to said tray.

10. The insert of claim 9 wherein said height-adjustable riser further comprises a plurality of protrusions inwardly movable toward said riser.

11. The insert of claim 1 wherein said bottom surface of said tray further comprises a perforated plate that is removable from said tray for riser positioning in a non-central position relative to said tray.

12. The insert of claim 1 wherein said tray is configured for holding plants selected from a group consisting of one centrally located plant, potted plants, plants rooted in growth medium dispersed directly into said tray, and plants rooted in support medium dispersed directly by said tray.

13. The insert of claim 1 wherein said riser is lockable against unauthorized access to said controller.

14. The insert of claim 1 wherein said tray has a fill-hole configured for reservoir fluid replenishment without removal of said tray from said lip, said fill-hole configured to deliver fluid from a source positioned above said tray directly into said reservoir.

15. The insert of claim 1 wherein said controller is programmable.

16. The insert of claim 1 further comprising at least one battery in electrical communication with said controller.

17. A method of self-contained, automated irrigation of container-grown plants, said method comprising the steps of:
providing said insert of claim 1, a planter, at least one plant, plant support medium, and plant growth fluid;
placing said reservoir into said planter;
placing said pump and said plant growth fluid into said reservoir;
associating said solar panel unit with said riser;
securing said riser for support by said tray at a desired height relative to said tray and so that said solar panel unit will be positioned above said tray when said tray becomes supported by said reservoir;
electrically connecting said pump and said solar panel unit to said controller;
connecting said pump to said drip line;
placing said plant support medium in said tray;
rooting said at least one plant within said plant support medium; and
lowering said tray onto said lip of said reservoir, wherein when said controller activates said pump, said plant growth fluid is delivered via said drip line to said growth medium for automated irrigation of said at least one plant supported by said tray, with excess plant growth fluid returning to said reservoir for recycling through said perforations in said tray.

18. The method of claim 17 further comprising the steps of providing at least one plant growth pot, placing said plant support medium in said at least one plant growth pot, and placing said combined plant growth pot and said plant support medium on said bottom surface of said tray.

19. The method of claim 17 wherein said plant growth fluid is water.

20. The method of claim 17 wherein the order of said steps of placing said reservoir into said planter, placing said pump and said plant growth fluid into said reservoir, associating said solar panel unit with said riser, securing said riser for support by said tray, electrically connecting said pump and said solar panel unit to said controller, and connecting said pump to said drip line, is not critical.
